(19) United States
(12) Patent Application Publication
(10) Pub. No.: US 2026/0180103 A1
(43) Pub. Date: Jun. 25, 2026

(54) VEHICLE BODY STRUCTURE

(71) Applicant: HONDA MOTOR CO., LTD., Tokyo (JP)

(72) Inventors: Yuki MURAMATSU, Tokyo (JP); Yuki MATSUSHIMA, Tokyo (JP); Akira YAMASHITA, Tokyo (JP)

(21) Appl. No.: 19/398,319

(22) Filed: Nov. 24, 2025

(30) Foreign Application Priority Data
Dec. 25, 2024 (JP) 2024-229481

(51) Int. Cl. H01M 50/249; B60R 16/04; B62D 21/02; H01M 50/271

(52) U.S. Cl. CPC H01M 50/249; B60R 16/04; B62D 21/02; H01M 50/271; H01M 2220/20

(57) ABSTRACT

The present invention provides a vehicle body structure which can efficiently dispose a cross member while it can firmly support a seat, wherein vehicle body structure includes a vehicle body frame and the battery case attached to the vehicle body frame, wherein the battery case includes an accommodating portion that accommodates a battery, and a battery cover that covers the accommodating portion from above, wherein a cross member extending along the vehicle width direction and a seat support frame extending from the cross member in the vehicle front-rear direction and supporting a seat of the vehicle are disposed on an upper surface of the battery cover.

### REFERENCE TO RELATED APPLICATIONS

The present invention relates to and asserts priority from Japanese patent application No. 2024-229481 filed on December 25, 2024, and incorporates the entirety of the contents and subject matter of all the above application herein by reference.

### BACKGROUND OF THE INVENTION

### 1. Technical Field

The present invention relates to a vehicle body structure.

### 2. Background Art

In recent years, research and development has been conducted on weight reduction to contribute to energy efficiency, so that more people can access affordable, reliable, sustainable, and advanced energy.

For example, a conventional vehicle is known that includes a pair of side members, first and second cross members that are orthogonal to the pair of side members, and a recessed space that is surrounded by the pair of side members and the first and second cross members and in which a battery is disposed (for example, Patent Document 1: Japanese Patent Application Publication No. 2015-223925).

In such a structure, a lid member is provided which closes an upper opening of the recessed space and has an upper surface flush with a floor surface of the vehicle. Further, a third cross member that extends in the same direction as the first cross member and the second cross member is disposed on the lower surface of the lid member. Seat rail brackets are installed on the first cross member and the third cross member to attach the seat.

In the present technology relating to weight reduction, it is a problem to efficiently arrange the cross member while firmly supporting the seat.

However, in the conventional technique, the cross members (the first cross member and the third cross member) are disposed in the recessed space, and the battery is accommodated between the first and third cross members. Therefore, the cross member needs to be disposed at a position corresponding to the size of the battery.

Further, since the seat bracket is installed on the cross member, the cross member needs to be arranged according to the seat position.

Further, the cross member is a member that contributes to strength performance and rigidity performance of the vehicle body. Therefore, it is necessary to arrange the cross member at a more efficient position in order to satisfy these performances.

Therefore, when there are restrictions due to the battery size and the seat mounting position, the cross member cannot be disposed at a position optimal for the rigidity and strength performances. Therefore, there is a problem that reinforcement is required, which leads to an increase in weight, and there is room for further improvement.

The present application has been made to solve the above problem, and an object of the present application is to provide a vehicle body structure that can firmly support a seat and efficiently arrange a cross member. This contributes to energy efficiency.

### SUMMARY OF INVENTION

In order to solve the above problem, a vehicle body structure of the present invention includes a vehicle body frame and a battery case attached to the vehicle body frame. The battery case includes an accommodating portion that accommodates a battery, and a battery cover that covers the accommodating portion from above. A cross member extending along a vehicle width direction and a seat support frame extending from the cross member in a vehicle front-rear direction and supporting a seat of the vehicle are installed on an upper surface of the battery cover.

According to the present invention, the vehicle body structure is provided that can firmly support a seat and efficiently arrange a cross member.

### BRIEF DESCRIPTION OF DRAWINGS

FIG. 1 is a plan view of a vehicle body structure according to a first embodiment of the present invention, with a seat removed, showing a lower portion of a vehicle from above.

FIG. 2 is a plan view illustrating a configuration of a main part of the vehicle body structure.

FIG. 3 is a perspective view showing a configuration of an upper surface of a battery case.

FIG. 4 is a cross-sectional view taken along line IV-IV in FIG. 3, showing a relationship between a seat support frame and a floor panel.

FIG. 5 is a cross-sectional view taken along line V-V in FIG. 3, showing a relationship between the seat support frame and a cross member.

FIG. 6 is a plan view of a modification example in which the width of the upper surface portion is changed in the sheet support frame.

FIG. 7 is a perspective view showing a configuration in the vicinity of a side sill.

FIG. 8 is a perspective view showing a configuration of a main part in a vehicle body structure of a second embodiment.

### DESCRIPTION OF EMBODIMENTS

Hereinafter, embodiments of the present invention will be described with reference to the drawings as appropriate. The same components are denoted by the same reference numerals, and redundant description will be omitted. Further, directions are described based on front, rear, left, right, up, and down directions as viewed from a driver of the vehicle. The vehicle width direction and the left-right direction are synonymous.

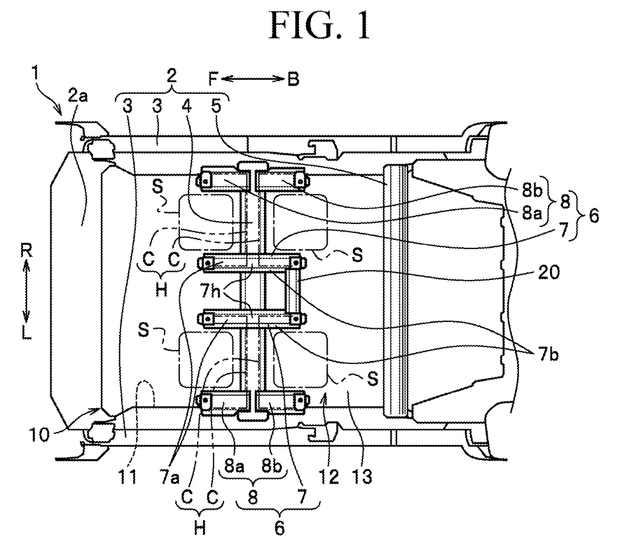

FIG. 1 shows a vehicle body structure used in a vehicle 1 of a first embodiment.

A vehicle body frame 2 constituting a lower portion of the vehicle 1 has a pair of side sills 3, 3 extending in vehicle front-rear direction from both left and right sides of a dash panel 2a provided mainly in a front portion of a cabin. The vehicle body frame 2 includes a cross member 4 and a rear cross member 5 extending along the vehicle width direction and connecting the side sills 3, 3.

A battery case 10 is attached to the vehicle body frame 2.

The battery case 10 includes a recessed accommodating portion 11 that accommodates a battery, and a flat plate shaped battery cover 12 that covers the accommodating portion 11 from above. In the present embodiment, the battery cover 12 constitutes a floor panel of the vehicle body. Please note that the term “a battery” means not only one battery but also a plurality of the batteries.

A cross member 4 having a hat-shaped cross section is disposed on an upper surface 13 of the battery cover 12 at an intermediate position in the vehicle front-rear direction. Further, the rear cross member 5 is disposed on the upper surface 13 of the battery cover 12 at a predetermined distance from the cross member 4 in the vehicle front-rear direction.

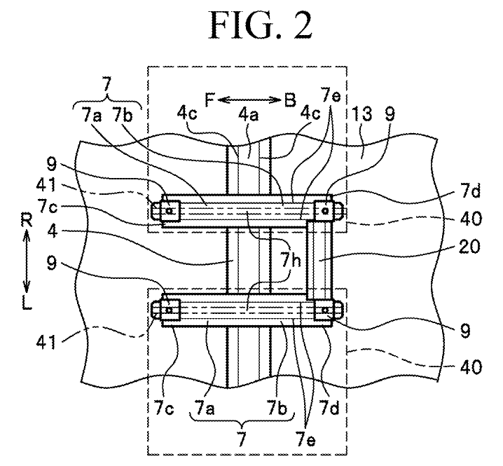

The cross member 4 has cross member ridge line portions 4c extending in the vehicle width direction between the upper surface 4a and the side walls (see FIG. 2).

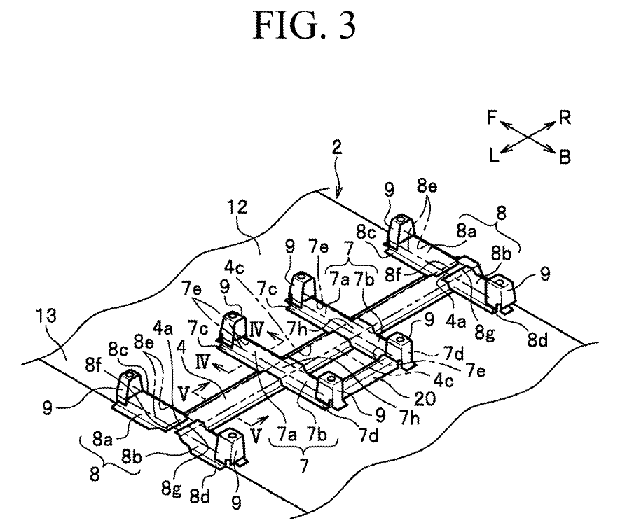

As shown in FIG. 3, each cross member ridge line portion 4c is formed continuously and linearly in a range from a left end portion to a right end portion in the vehicle width direction without being bent in the vertical direction.

Further, a plurality of seat support frames 6 for supporting a seat 40 (see FIG. 2) of the vehicle 1 are disposed on the upper surface 13 of the battery cover 12. The seat support frame 6 includes a pair of inner support frames 7 provided near the center in the vehicle width direction, and a pair of outer support frames 8 provided near the left and right side edges of the battery cover 12 in the vehicle width direction.

The inner support frame 7 and the outer support frame 8 on the right side of the vehicle are paired to support the right side front seat 40. Further, the inner support frame 7 and the outer support frame 8 on the left side of the vehicle are paired to support the left side front seat 40.

A seat slide rail 41 is provided below of each seat 40, and a seat surface portion of the seat 40 is slidable in the vehicle front-rear direction. The entire length of the inner support frame 7 and the outer support frame 8 of the first embodiment is set to be substantially the same as the entire length of the seat slide rail 41.

As shown in FIG. 2, the inner support frames 7 are provided in a pair side by side at the center in the vehicle width direction. Each inner support frame 7 has a first frame portion 7a extending forward from the cross member 4 and a second frame portion 7b extending rearward from the cross member 4.

The inner support frame 7 of the first embodiment has a joining frame portion 7h joining the first frame portion 7a and the second frame portion 7b, and is integrally and continuously formed in the vehicle front-rear direction.

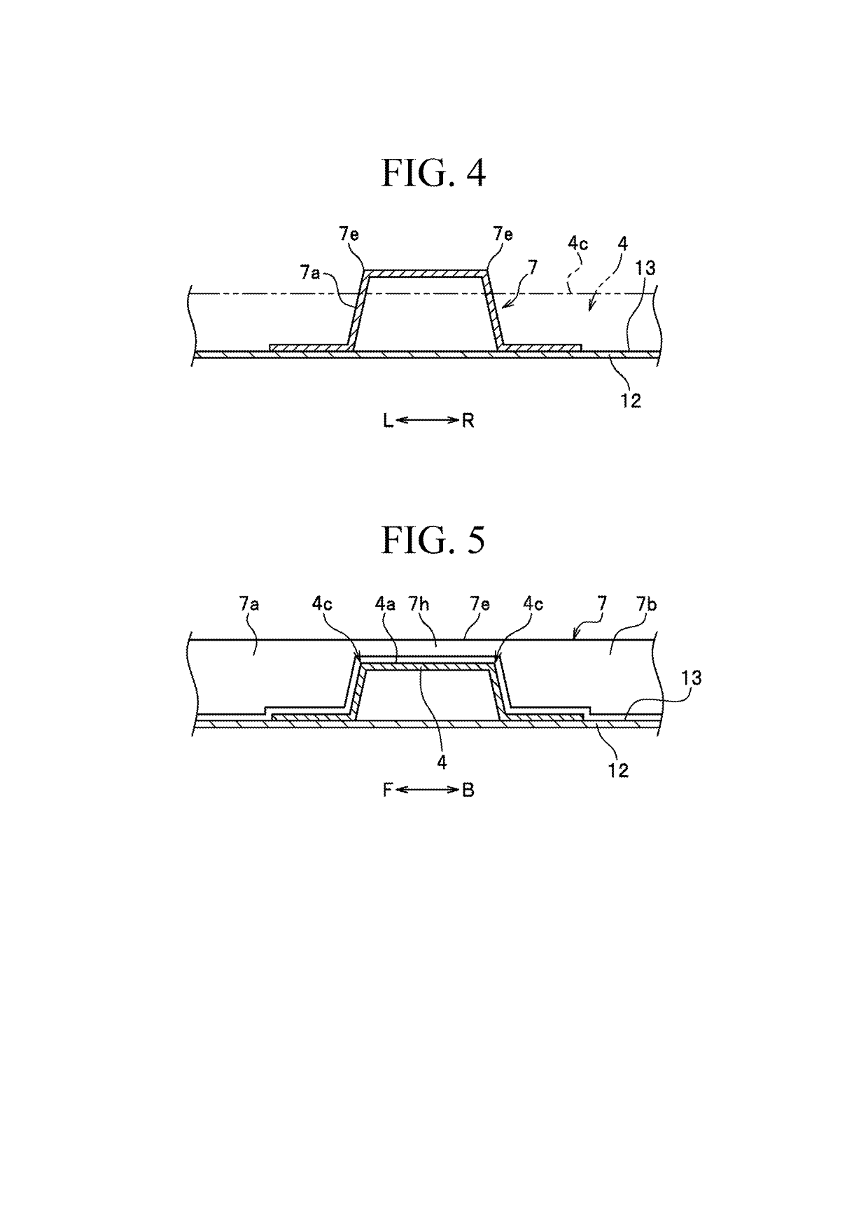

As shown in FIG. 4, the inner support frame 7 is formed to have a substantially hat-shaped cross section and a vertical dimension larger than that of the cross member 4.

The inner support frame 7 is provided so as to straddle the cross member 4 from above, and flange portions formed on the left and right sides in the vehicle width direction of the first frame portion 7a and the second frame portion 7b are joined to the upper surface 13 of the battery cover 12.

The joining frame portion 7h of the inner support frame 7 is engaged with the cross member 4 from above at the concave portion on the lower surface side, and the flange portions located on the left and right sides are joined to the upper surface 4a and the front and rear side walls of the cross member 4. (See FIG. 5)

Accordingly, the inner support frame 7 is orthogonal to the cross member 4, and a frame ridge line portion 7e and a cross member ridge line portion 4c, which will be described later, are separated from each other in the vertical direction and intersect each other in the plan view.

The first frame portion 7a and the second frame portion 7b extend from the cross member 4 in the vehicle front-rear direction by substantially the same length, and are fixed to the battery cover 12.

Further, seat mounting brackets 9, 9 are provided on a front end portion 7c of the first frame portion 7a and a rear end portion 7d of the second frame portion 7b. The seat mounting brackets 9, 9 are mounted with a front end portion and a rear end portion of the seat slide rail 41, and support the seat slide rail 41 from below.

The inner support frame 7 of the seat support frame 6 has a frame ridge line portion 7e extending in the vehicle front-rear direction. The frame ridge line portion 7e is formed so as to extend continuously in the vehicle front-rear direction without being bent in the vertical direction in a range from a seat support point provided on the front end portion 7c on the first frame portion 7a to a seat support point provided on the rear end portion 7d on the second frame portion 7b in the vehicle body front-rear direction.

As shown in FIG. 1, the inner support frame 7 is configured such that the front end portion 7c of the first frame portion 7a is not extended forward to the dash panel 2a but is spaced apart from the dash panel 2a. Thus, the front end portion 7c is not connected to the dash panel 2a. Further, the rear end portion 7d of the second frame portion 7b is not extended to the rear cross member 5 but is spaced apart from the rear cross member 5. Thus, the rear end portion 7d is not connected to the rear cross member 5.

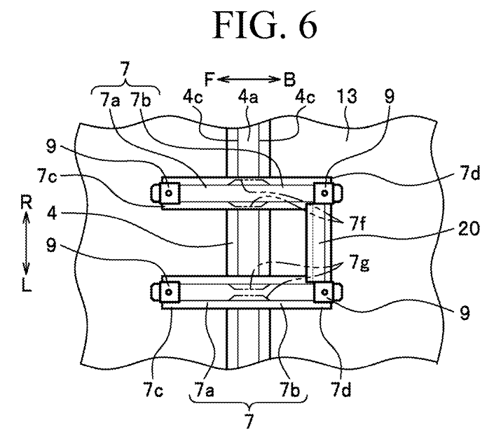

FIG. 6 shows a vehicle body structure according to a modification of the first embodiment, in which the width of the upper surface portion of the inner support frame 7 is changed in the vehicle width direction so that the frame ridge line portion is allowed to be curved in the plan view.

In this case, the right side inner support frame 7 has, at its center, bulging portions 7f and 7f that expand in the vehicle width direction. Further, at the center of the left side inner support frame 7, there are formed recessed portions 7g and 7g which are narrowed in the vehicle width direction. However, the shape of the frame ridge line portion in the plan view is not particularly limited to this. For example, the shape may be symmetrical in left-right direction, or may be formed in a non-linear shape having a curved shape or a concavo-convex shape asymmetrical to the left and right.

That is, as in the frame ridge line portion 7e of the inner support frame 7 shown in a side view in FIG. 5, the frame ridge line portion may be formed linearly and continuously without being bent in the vertical direction in a range from the front sheet support point of the first frame portion 7a to the rear sheet support point of the second frame portion 7b.

The vehicle body structure of the first embodiment includes a reinforcing member 20 that is laid on the upper surface 13 of the battery cover 12 and extends in the vehicle width direction.

The reinforcing member 20 has a hat-shaped cross section and connects the rear ends 7d and 7d of the pair of inner support frames 7 and 7 adjacent to each other in the vehicle width direction.

Further, the reinforcing member 20 has flange portions located in both sides of vehicle front-rear direction, and the flange portions are joined to the upper surface 13 of the battery cover 12. The reinforcing member 20 has left and right end portions connected to the rear end portions 7d and 7d of the pair of inner support frames 7 and 7 disposed adjacent to each other.

This further strengthens the connection between the seat support frames 6 supporting the left and right seats 40. A load input from one of the seats 40 to the seat support frame 6 is transmitted to the inner support frame 7 of the other seat 40 disposed adjacent thereto via the inner support frame 7 and the reinforcing member 20, and is dispersed in the vehicle width direction.

The outer support frame 8 provided on the outer side of the inner support frame 7 in the vehicle width direction is disposed along the inner side of the side sill 3.

As shown in FIG. 3, the outer support frame 8 has a first frame portion 8a and a second frame portion 8b. The first frame portion 8a and the second frame portion 8b of the first embodiment are formed of independent separate members having a substantially hat-shaped cross section, and are arranged in the vehicle front-rear direction to form the outer support frame 8.

The first frame portion 8a extends forward from the cross member 4, and is laid on and joined to the upper surface 13 of the battery cover 12.

The second frame portion 8b extends rearward from the cross member 4 and is laid on and joined to the upper surface 13 of the battery cover 12.

Seat mounting brackets 9, 9 are provided on a front end 8c of the first frame portion 8a and a rear end 8d of the second frame portion 8b, respectively, for mounting the front end and the rear end of the seat slide rail 41 and supporting the seat slide rail 41 from below.

Further, in the outer support frame 8, a rear end 8f of the first frame portion 8a and a front end 8g of the second frame portion 8b are joined in the vertical direction to the upper surface 4a of each of the left and right end portions of the cross member 4.

In the outer support frame 8 shown in FIG. 3, the front end 8c of the first frame portion 8a is not extended forward to the dash panel 2a shown in FIG. 1 but is spaced apart from the dash panel 2a. The front end 8c is not connected to the dash panel 2a. Further, the rear end 8d of the second frame portion 8b is not extended to the rear cross member 5 but is spaced apart from the rear cross member 5. The rear end 8d is not connected to the rear cross member 5.

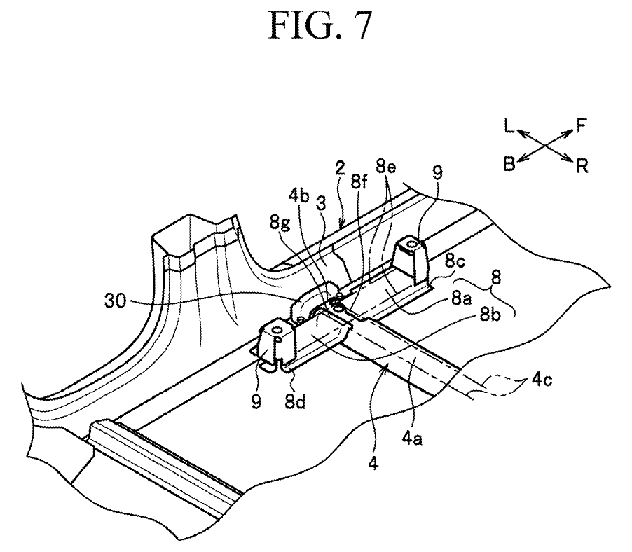

Further, in the vehicle body structure of the first embodiment, as shown in FIG. 7, a pair of left and right extension members 30 are provided to protrude from the inner wall surfaces of the pair of left and right side sills 3 toward the center in the vehicle width direction.

The side end portions 4b and 4b of the cross member 4 located on the left and right sides are joined to the extension members 30 so as to cover the extension members 30 from above. Thus, side end portions 4b located on both left and right sides of the cross member 4 are connected to the vehicle body frame 2 via the extension members 30, respectively.

Therefore, the loads applied to the first frame portion 7a and the second frame portion 7b of the inner support frame 7 and the first frame portion 8a and the second frame portion 8b of the outer support frame 8, which support the seat 40, are transmitted to the side sills 3 of the vehicle body frame 2 located on the left and right sides of the vehicle via the cross member 4 and the extension members 30, respectively, and are dispersed.

As shown in FIG. 1, in the vehicle body structure of the first embodiment, a U-shaped support structure C having a U-shape opening forward and rearward in the plan view is formed by a cross member 4 extending in the vehicle width direction and two inner support frames 7 and two outer support frames 8 extending in vehicle front-rear direction below left and right side seats.

The front and rear portions of the seat 40 are supported from below by the front and rear U-shaped support structures C, respectively.

As shown in FIG. 1, in the first embodiment, the pair of front and rear U-shaped support structures C and C are combined back to back to form an H shape corresponding to each seat. Thus, the cross member 4 extending in the vehicle width direction and the two inner support frames 7 and the two outer support frames 8 extending in the vehicle front-rear direction are configured to form an H-shaped support structure H having an H shape in the plan view. Therefore, the seat 40 is firmly supported from below by the H-shaped support structure H.

The load applied from the seat 40 is transmitted to the first frame portion 7a and the second frame portion 7b of the inner support frame 7 and the first frame portion 8a and the second frame portion 8b of the outer support frame 8.

The load is received and supported in a planar manner from below by the H-shaped support structure H in which the U-shaped support structures C, C are combined with each other with the cross member 4 interposed therebetween. The load of the seat 40 is transmitted to the side sills 3 located on the left and right sides of the vehicle via the cross member 4 and the extension members 30, and is efficiently dispersed to the vehicle body frame 2.

In the vehicle body structure of the first embodiment configured as described above, the arrangement position of the cross member 4 is not restricted by the attachment position of the seat 40, and the cross member 4 can be arranged at a position optimal for the rigidity and strength performances.

Therefore, the degree of freedom of the arrangement position of the cross member is increased, and thus the required rigidity of the vehicle body frame can be easily obtained. Therefore, the rigidity and strength performances of the cross member 4 are not sacrificed by the restriction of the battery size and the mounting position of the seat 40, and reinforcement which has been required in the conventional structure is not required. Therefore, the vehicle body structure of the first embodiment can select the battery size while suppressing an increase in the vehicle body weight.

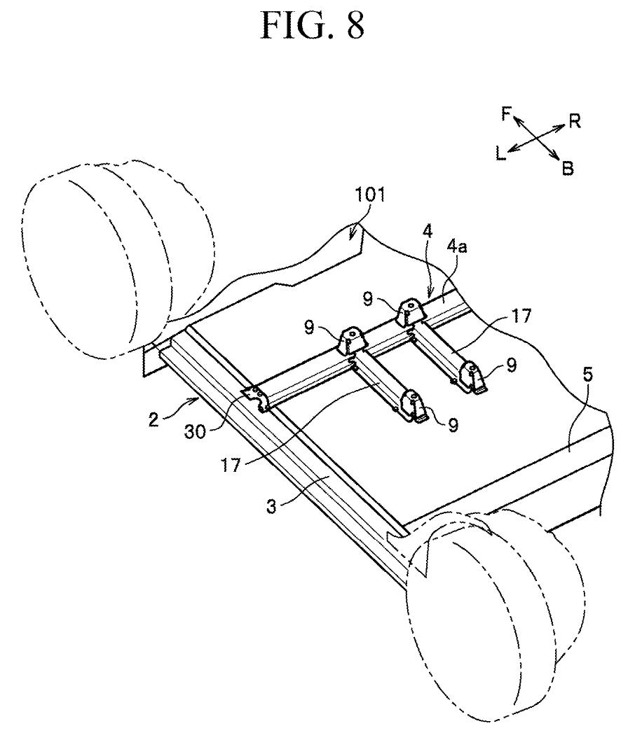

FIG. 8 shows a vehicle body structure according to a second embodiment of the present invention. Note that portions that are the same as or equivalent to those of the vehicle body structure of the first embodiment are denoted by the same reference numerals.

The vehicle body structure of the second embodiment includes the cross member 4 extending in the vehicle width direction of a vehicle 101, and two seat support frames 17, 17 extending from the cross member 4 toward the vehicle rear side.

The cross member 4 and the seat support frames 17, 17 form the U-shaped support structure C having the U-shape opening rearward in the plan view. The seats located on both the left and right sides are configured to be supported by the U-shaped support structure C by attaching the slide rails located on the inner sides of the respective seats to the seat attachment brackets 9 and 9.

The front side seat mounting brackets 9 are mounted on the cross members 4, respectively. The rear side seat mounting brackets 9 are disposed on the seat support frames 17.

In the second embodiment, as shown in FIG. 8, the U-shaped support structure C having the U-shape that is open only rearward in the plan view is formed. However, the present invention is not particularly limited thereto, and the two seat support frames 17, 17 extending from the cross member 4 toward the front of the vehicle may be provided to form the U-shaped support structure C having the U-shape that is open only forward in the plan view.

Other configurations and operational effects are similar to those of the vehicle body structure of the first embodiment, and therefore, the description thereof will be omitted.

As described above, the vehicle body structure of the present embodiments of the present invention is applied to the vehicle 1 including the vehicle body frame 2 and the battery case 10 attached to the vehicle body frame 2. The battery case 10 includes the accommodating portion 11 that accommodates the battery, and the battery cover 12 that covers the accommodating portion 11 from above. The cross member 4 extending along the vehicle width direction and the seat support frame 6 extending from the cross member 4 in the vehicle front-rear direction and supporting the seat 40 of the vehicle 1 are installed on the upper surface 13 of the battery cover 12.

The vehicle body structure of the present embodiments of the present invention configured as described above is provided with the vehicle body structure that can firmly support the seat 40 and can efficiently arrange the cross member 4.

Specifically, since the cross member 4 is disposed on the upper surface of the battery case 10, the installation position of the cross member 4 is not limited by the size of the battery accommodated in the accommodating portion 11.

The seat support frame 6 extending in the vehicle front-rear direction from the cross member 4 is supported from below by the upper surface 13 of the battery cover 12.

Therefore, even if the position supporting the seat 40 is separated from the cross member 4 in the vehicle front-rear direction, the seat support frame 6 can disperse the load to the cross member 4 and the battery cover 12, and can firmly support the seat 40.

Further, the seat support frame 6 includes first frame portions 7a and 8a connected to the cross member 4 and extending toward the front of the vehicle body, and second frame portions 7b and 8b connected to the cross member 4 and extending toward the rear of the vehicle body. The seat 40 is supported by the first frame portions 7a and 8a and the second frame portions 7b and 8b.

Therefore, the first frame portion 7a and the second frame portion 7b can support the seat 40 at positions away from the cross member 4 in the vehicle front-rear direction.

The first frame portion 8a and the second frame portion 8b can support the seat 40 at positions separated from the cross member 4 in the vehicle front-rear direction.

This increases the degree of freedom in the arrangement of the cross member 4, and the cross member 4 can be arranged at the center of the seat 40 in the vehicle front-rear direction as shown in FIG. 1. Therefore, a foot space S of a passenger seated on the front and rear seats 40 is widened, and the floor surface can be formed to be low and flat. Therefore, the seat can be firmly supported, and the space efficiency in the vehicle cabin can be further improved.

The plurality of seat support frames 6 are arranged side by side in the vehicle width direction, and the rear end portions 7d and 7d of the pair of adjacent inner support frames 7 and 7 are connected to each other by the reinforcing member 20 extending in the vehicle width direction.

Therefore, the inner support frame 7 and the reinforcement member 20 can transmit the load input from the seat 40 to the seat support frame 6 to the other seat support frames 6 including the inner support frame 7 disposed adjacent thereto, and can disperse the load in the vehicle width direction. Therefore, the seat support rigidity can be further improved.

Further, as shown in FIG. 1, the H-shaped support structure H having the H shape in the plan view is formed by the cross member 4 extending in the vehicle width direction and the two seat support frames 6 extending in the vehicle front-rear direction. The seat 40 is supported by the H-shaped support structure H.

Even if the seat attachment point and the cross member 4 are disposed apart from each other in the vehicle front-rear direction, the H-shaped support structure H can firmly support the seat 40.

Further, since the seat support frame 6 is disposed at a position avoiding the feet of the passenger seated on the seat 40 by forming the seat support frame 6 in the H-shape, the foot space S is not blocked, and the floor surface is lowered.

As shown in FIG. 1, the H-shaped support structures H are arranged side by side in the vehicle width direction. The adjacent H-shaped support structures H are connected by the reinforcing member 20 extending in the vehicle width direction.

Therefore, the reinforcing member 20 can transmit the load input from the seat 40 to the H-shaped support structure H to the other adjacent H-shaped support structure H and disperse the load in the vehicle width direction. Therefore, the sheet 40 is more firmly supported by the H-shaped support structure H.

The reinforcing member 20 is disposed between the left and right side seats 40. Therefore, the seat support rigidity can be improved without obstructing the foot space S of the passenger.

The cross member 4 extending in the vehicle width direction and the two inner support frames 7 and the two outer support frames 8 extending in the front-rear direction form the U-shaped support structure C having the U-shape opening forward or rearward in the plan view.

Further, at least the part of the sheet 40 is supported by the U-shaped support structure C. Therefore, even if the seat attachment point is provided on the seat support frame 6 away from the cross member 4 in the vehicle front-rear direction, the seat 40 can be firmly supported by the U-shaped support structure C.

The pair of right and left U-shaped support structures C are arranged side by side in the vehicle width direction to support the seat 40, and the pair of adjacent U-shaped support structures C are connected by the reinforcing member 20 extending in the vehicle width direction.

Thus, the load input from the right and left seats 40 to the U-shaped support structure C is dispersed in the vehicle width direction by the reinforcing member 20. Therefore, the sheet 40 can be supported more firmly.

Further, as shown in FIGS. 1 and 2, the seat 40 is supported by the U-shaped support structure C, so that the seat support frame 6 and the reinforcing member 20 are disposed at positions avoiding the feet of the passenger seated on the seat 40. Therefore, the floor surface can be formed low and flat, and the seat support rigidity can be improved without obstructing the foot space S of the passenger seated on the seat 40.

As shown in FIG. 3, the seat support frame 6 has the frame ridge line portion 7e extending in the vehicle front-rear direction. The frame ridge line portion 7e is formed linearly in the vehicle side view and is continuously formed without being bent in the vertical direction in a range from the seat mounting bracket 9 on the first frame portion 7a side to the seat mounting bracket 9 on the second frame portion 7b side in the vehicle body front-rear direction.

Thus, the frame ridge line portion 7e of the seat support frame 6 is not bent in the vertical direction, which may cause the bending. Therefore, the deflection of the seat support frame 6 due to the load input from the seat 40 is suppressed, and the seat 40 can be supported more firmly.

The size of the upper surface of the seat support frame 6 in the vehicle width direction may be increased or decreased as shown in the bulging portion 7f or the recessed portion 7g in FIG. 6. That is, the frame ridge line portion 7e may have a bent or curved shape in the plan view.

As shown in FIG. 3, the cross member 4 has the cross member ridge line portion 4c extending in the vehicle width direction. The cross member ridge line portion 4c is formed in linear shape as viewed in the vehicle front-rear direction, and is formed continuously in the vehicle width direction without being bent in the vertical direction.

Therefore, the cross member ridge line portion 4c of the cross member 4 does not have the bend in the vertical direction that triggers a break. Therefore, the deflection of the seat support frame 6 due to the load input from the seat 40 is suppressed, and the seat 40 can be supported more firmly.

The inner support frame 7 of the seat support frame 6 has the frame ridge line portion 7e extending in the vehicle front-rear direction. The frame ridge line portion 7e is formed continuously without being bent in the vertical direction in a range from the front seat support point of the first frame portion 7a to the rear seat support point of the second frame portion 7b in the vehicle front-rear direction. The cross member 4 has the cross member ridge line portion 4c extending in the vehicle width direction, and the cross member ridge line portion 4c is formed continuously in the vehicle width direction without being bent in the vertical direction. Further, the frame ridge line portion 7e and the cross member ridge line portion 4c are separated from each other in the vertical direction and intersect each other in the plan view.

Accordingly, the bending in the vertical direction, which triggers the bending of the frame ridge line portion 7e, does not exist in the range from the front sheet support point to the rear sheet support point. Therefore, the deflection of the inner support frame 7 due to the load input from the seat 40 is suppressed, and the seat 40 can be firmly supported.

Further, since there is no bending in the vertical direction which may cause the cross member ridge line portion 4c to be bent, the deflection of the inner support frame 7 due to the load input from the seat 40 is suppressed, and the seat 40 can be firmly supported.

Further, as shown in FIG. 5, the frame ridge line portion 7e and the cross member ridge line portion 4c intersect with each other while being vertically separated from each other. Therefore, the frame ridge line portion 7e and the cross member ridge line portion 4c can be made orthogonal to each other without bending both ridge lines, and the seat 40 can be supported more firmly.

The outer support frame 8 of the seat support frame 6 has the frame ridge line portion 8e extending in the vehicle front-rear direction.

The frame ridge line portion 8e is formed in the range from the seat support point on the first frame portion 8a side to the seat support point on the second frame portion 8b side in the vehicle front-rear direction. The cross member 4 has the cross member ridge line portion 4c extending in the vehicle width direction. The cross member ridge portion 4c is formed continuously in the vehicle width direction without being bent in the vertical direction, and the first frame 8e and the second frame 8b are joined to the cross member 4 in the vertical direction at the position where the frame ridge line portion 8e and the cross member ridge line portion 4c intersect with each other in the plan view.

Therefore, even if the seat support frame 6 is divided into front and rear portions as in the outer support frame 8 shown in FIG. 7, desired strength can be obtained by joining the frame ridge line portion 8e and the cross member ridge line portion 4c in the vertical direction at the respective end portions facing each other.

Further, in the first embodiment shown in FIG. 7, the load applied from the seat 40 can be transmitted to the side sills 3 provided on the left and right side edge portions of the vehicle body frame 2 via the outer support frames 8 and the side end portions 4b of the cross member 4. Therefore, the load is dispersed in the vehicle width direction, and the seat 40 can be supported more firmly.

As shown in FIG. 7, the pair of left and right extension members 30 are provided to be fixed to the pair of left and right side sills 3, 3 provided on the vehicle body frame 2. The side end portions 4b on both left and right sides of the cross member 4 are connected to the vehicle body frame 2 via the pair of left and right extension members 30, respectively.

Therefore, the cross member 4 is connected to the vehicle body frame 2 via the extension member 30. Therefore, it is possible to demonstrate practically beneficial effects such as the seat 40 can be held more firmly, and the rigidity of the vehicle body can be ensured.

The present invention is not limited to the above-described embodiment, and various modifications can be made. The above-described embodiments are examples for easy understanding of the present invention, and the present invention is not necessarily limited to those having all the configurations described above. In addition, a part of the configuration of a certain embodiment can be replaced with the configuration of another embodiment, and the configuration of another embodiment can be added to the configuration of a certain embodiment. In addition, a part of the configuration of each embodiment

The configuration may be deleted, or another configuration may be added or replaced. Possible modifications of the above embodiment are, for example, as follows.

The vehicle body structure of the first embodiment is formed with the H-shaped support structure H having the H shape in the plan view, and is configured such that the H-shaped support structure H supports the seat 40. However, the present invention is not particularly limited to this. For example, the U-shaped support structure C having the U-shape opening forward or rearward in the plan view may be arranged on either one of the front and rear sides, and the seat 40 may be supported by one U-shaped support structure C.

That is, the cross member 4 extending along the vehicle width direction and the seat support frame 6 extending from the cross member 4 in the vehicle front-rear direction and supporting the seat 40 may be installed on the upper surface 13 of the battery cover 12. As described above, in the vehicle body structure of the present invention, the shape, the number, and the material of the seat support frame 6 are not particularly limited.

1 vehicle; 2 vehicle body frame; 4 Cross member; 6 seat support frame; 10 battery case; 11 Accommodating portion; 12 battery cover; 40 seat

What is claimed is:

1. A vehicle body structure includes a vehicle body frame and a battery case attached to the vehicle body frame;
wherein the battery case includes:
an accommodating portion that accommodates a battery;
a battery cover that covers the accommodating portion from above;
wherein, on an upper surface of the battery cover, a cross member extending along a vehicle width direction and a seat support frame extending from the cross member in a vehicle front-rear direction while supporting a seat of the vehicle are disposed.

2. The vehicle body structure according to claim 1, wherein the seat support frame includes a first frame portion connected to the cross member and extending toward the front of the vehicle body, and a second frame portion connected to the cross member and extending toward the rear of the vehicle body, wherein the seat is supported by the first frame portion and the second frame portion.

3. The vehicle body structure according to claim 1, further comprising a reinforcing member;
wherein the seat support frame includes a plurality of seat support frames arranged side by side in a vehicle width direction, and the reinforcing member connects the adjacent seat support frames to each other in the vehicle width direction.

4. The vehicle body structure according to claim 1, wherein the cross member extending in the vehicle width direction and the two seat support frames extending in the vehicle front-rear direction form an H-shaped support structure having an H shape in the plan view, wherein the seat is supported by the H-shaped support structure.

5. The vehicle body structure according to claim 4, wherein a plurality of the H-shaped support structures are arranged side by side in the vehicle width direction,
wherein the adjacent H-shaped support structures are connected by a reinforcing member extending in the vehicle width direction.

6. The vehicle body structure according to claim 1, wherein the cross member extending in the vehicle width direction and the two seat support frames extending in the vehicle front-rear direction form a U-shaped support structure having a U-shape opening forward or rearward in the plan view, wherein at least a part of the seat is supported by the U-shaped support structure.

7. The vehicle body structure according to claim 6, wherein the U-shaped support structures are formed as a pair of left and right U-shaped support structures arranged in a vehicle width direction and supporting respective seats, the pair of adjacent U-shaped support structures are connected by a reinforcing member extending in the vehicle width direction.

8. The vehicle body structure according to claim 2, wherein the seat support frame has a frame ridge line portion extending in the vehicle front-rear direction, the frame ridge line portion is formed in a linear shape in a vehicle side view and is continuously formed without being bent in the vertical direction in a range from the seat support point on the first frame portion side to the seat support point on the second frame portion side in the vehicle front-rear direction.

9. The vehicle body structure according to claim 1, wherein the cross member has a cross member ridge line portion extending in a vehicle width direction, the cross member ridge line portion is formed in a linear shape in a vehicle front-rear direction view and is continuously formed in the vehicle width direction without being bent in the vertical direction.

10. The vehicle body structure according to claim 2, wherein the seat support frame has a frame ridge line portion extending in a vehicle front-rear direction, the frame ridge line portion is formed continuously without being bent in the vertical direction in a range from a front seat support point of the first frame portion to a rear seat support point of the second frame portion in the vehicle front-rear direction,
wherein the cross member has a cross member ridge line portion extending in a vehicle width direction, wherein the cross member ridge line portion is formed continuously in the vehicle width direction without being bent in the vertical direction,
wherein the frame ridge line portion and the cross member ridge line portion are separated from each other in the vertical direction and intersect each other in the plan view.

11. The vehicle body structure according to claim 2, wherein the seat support frame has a frame ridge line portion extending in a vehicle front-rear direction, the frame ridge line portion is formed continuously in the vehicle front-rear direction in a range from a seat support point on the first frame portion side to a seat support point on the second frame portion side,
wherein the cross member has a cross member ridge line portion extending in a vehicle width direction, the cross member ridge line portion is formed continuously in the vehicle width direction without being bent in the vertical direction,
wherein the first frame portion and the second frame portion are joined to the cross member in the vertical direction at a location where the frame ridge line portion and the cross member ridge line portion intersect each other in the plan view.

12. The vehicle body structure according to claim 1, further comprising a pair of left and right extension members fixed to the vehicle body frame, respectively: wherein side end portions on both left and right sides of the cross member are connected to the vehicle body frame via the pair of left and right extension members.
